(19) United States
(12) Patent Application Publication
(10) Pub. No.: US 2012/0218769 A1
(43) Pub. Date: Aug. 30, 2012

(54) LED light module

(76) Inventors: John D. Van Horn, Bedford, TX (US); Richard I. Grant, JR., Irving, TX (US); Christopher M. LePage, Richland Hills, TX (US); Randy J. Kempf, Milford, IA (US)

(21) Appl. No.: 12/932,541

(22) Filed: Feb. 28, 2011

(51) Int. Cl. F21V 15/01; F21V 29/00

(52) U.S. Cl. 362/370; 362/373

(57) ABSTRACT

An LED light module for attachment to the outer end of a support arm extending from a support pole is disclosed. The LED light module includes a case having a clamp assembly secured thereto which is adapted to be clamped onto the outer end of the support arm. A module consisting of an LED panel, heat sink and power supply is selectively removably secured to the case as a unit or module so that the unit or module may be inserted into the case as a single unit or removed from the case as a single unit. The heat sink of the invention is comprised of a pair of heat sink members secured together. The power supply is secured to the heat sink at one end thereof with the LED panel secured to the bottom of the heat sink.

### BACKGROUND OF THE INVENTION

1. Field of the Invention

This invention relates to a LED light module for attachment to the outer end of a support arm which extends laterally from a support pole.

2. Description of the Related Art

Many types of light modules have been previously provided which are attached to the outer end of a support arm extending from a support pole. In recent years, the incandescent and mercury vapor light modules have been replaced with LED light modules. Generally speaking, most of the prior art LED light modules include a case or housing which houses an LED panel, a heat sink, a power supply and some means to attach the LED module to the outer end of the support arm. Although the prior art LED light modules do perform quite satisfactorily, they suffer from certain shortcomings or disadvantages. Usually, it is desirable to position the light module in a horizontally disposed position. If the outer end of the support arm is not horizontally disposed, the LED light module will likewise not be horizontally disposed. Another disadvantage is that the LED panel, heat sink and power supply are separately secured to the case. If the prior art LED module requires repair or replacement, the individual components must be removed from the case which usually is a two-person task. A further disadvantage in the prior art LED light modules is that they are designed to be secured to a support arm having a predetermined outside diameter. In other words, if the LED module is designed to be attached to a support arm having a three and one-quarter inch OD, the LED light module cannot be attached to a support arm having a one-half inch OD.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

An LED light module is disclosed which is adapted to be secured to the outer end of a support arm which extends outwardly from a vertically disposed support pole. The LED module of this invention includes a case having an inner wall, an outer wall, a bottom wall, opposite side walls and an open upper end which is selectively closable by a cover or lid. A clamp assembly is secured to the bottom wall of the case adjacent the inner end thereof. The outer end of the support arm extends through an opening in the inner wall of the case and is received by the clamp assembly. The clamp assembly includes structure to vertically adjust the case with respect to the support arm so that the case will be horizontally disposed. The case may be vertically adjusted without loosening the clamp assembly with respect to the support arm.

A module consisting of an LED panel, heat sink and power supply which are secured together is selectively removably secured to the bottom wall of the case adjacent the outer end thereof. The LED panel, heat sink and power supply module may be inserted into the case as a single unit and removed therefrom as a single unit or module to facilitate repair and/or replacement of the module.

It is therefore a principal object of the invention to provide an improved LED light module.

A further object of the invention is to provide a unique LED light module wherein a module consisting of an LED panel, heat sink and power supply which are secured together, may be inserted into the case of the LED module and removed therefrom as a single unit which enhances serviceability in both the manufacturing process and in the field.

A further object of the invention is to provide an LED light module including means for vertically adjusting the same with respect to the outer end of a support arm to which the LED light module is attached.

A further object of the invention is to provide an LED light module of the type described wherein the heat sink is comprised of a pair of heat sink members detachably secured together in an end-to-end relationship.

A further object of the invention is to provide an improved clamping assembly for attaching an LED light module to the outer end of a support arm which extends from a support pole.

A further object of the invention is to provide an LED light module including a clamping structure for attaching the LED light module to a support arm having different diameters.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a side view illustrating the LED light module of this invention secured to the outer end of a support arm which extends from a support pole;

FIG. 2 is a perspective view of the LED light module of this invention;

FIG. 3 is a partial exploded perspective view of the LED light module of this invention;

FIG. 4 is a perspective view illustrating the clamp assembly and the LED panel, heat sink and power supply module inserted into the case of the LED light module;

FIG. 5 is an exploded perspective view of the heat sink members of the heat sink assembly;

FIG. 6 is a perspective view of the heat sink assembly of this invention having a power supply secured to one end thereof;

FIG. 7 is an exploded perspective view illustrating the module consisting of an LED panel, heat sink assembly and power supply;

FIG. 8 is a perspective view of the clamp assembly of this invention;

FIG. 9 is an exploded perspective view of the clamp assembly of this invention;

FIG. 10 is a perspective view of the top clamp portion of the clamp assembly;

FIG. 11 is a perspective view of the top clamp of the clamp assembly in its reversed or second position;

FIG. 12 is an end view of the upper clamp in its first position;

FIG. 13 is a side view of the upper clamp of FIG. 12;

FIG. 14 is a perspective view illustrating the clamp assembly secured to the outer end of a support arm;

FIG. 15 is an end view illustrating the clamp assembly attached to a support arm;

FIG. 16 is a partial sectional view illustrating the clamp assembly secured to the outer end of a support arm;

FIG. 17 is an end view of the clamp assembly attached to the support arm with the upper clamp being in its second or reversed position; and

FIG. 18 is a sectional view of the LED light module of this invention.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

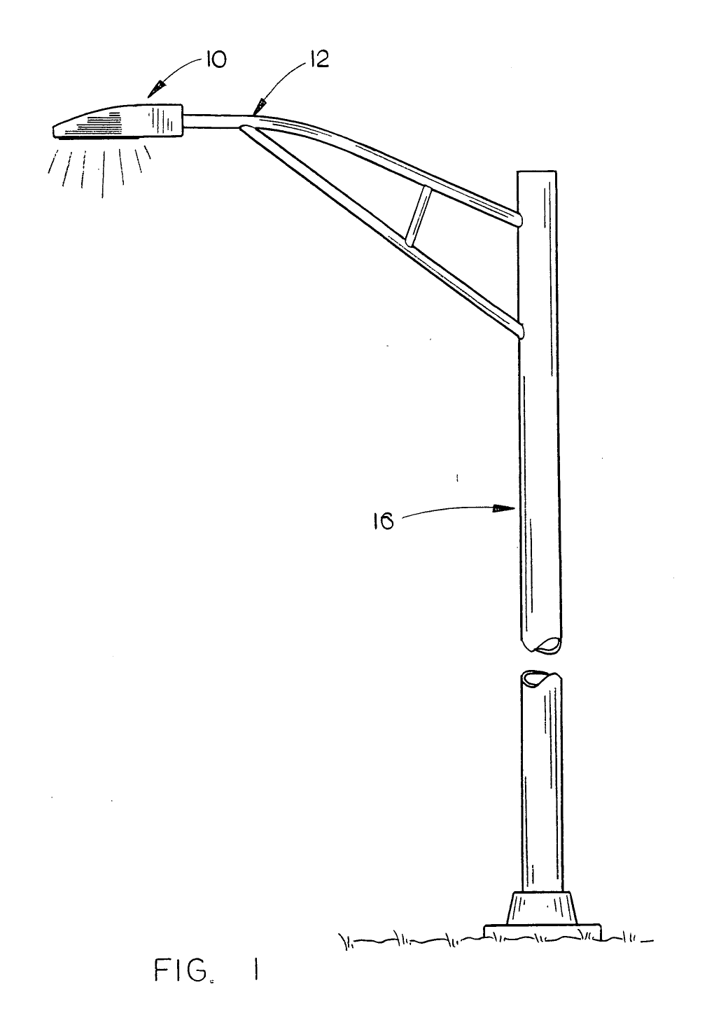

The numeral 10 refers to an LED light module of this invention which is designed to be secured to a tubular support arm 12 adjacent the outer end 14 thereof. Support arm 12 extends from a support pole 16, as seen in FIG. 1. LED light module 10 generally includes a case or housing 18, clamp assembly 20, heat sink assembly 22, power supply 24 and an LED panel 26. Case 18 is constructed of a metal material such as steel or the like. Case 18 will be described as including a bottom wall 28, an upstanding inner wall 30, a top wall portion 32 which extends outwardly from the upper end of inner wall 30, an upstanding outer wall 34, a top wall portion 36 which extends inwardly from the upper end of outer wall 34, an upstanding side wall 38 and an upstanding side wall 40. Inner wall 30 and top wall portion 32 may be of two-piece construction or of one-piece construction. Outer wall 34 and top wall portion 36 may be of two-piece construction or of one-piece construction. A cover 41 is secured to the upper end of case 18 to selectively close the same.

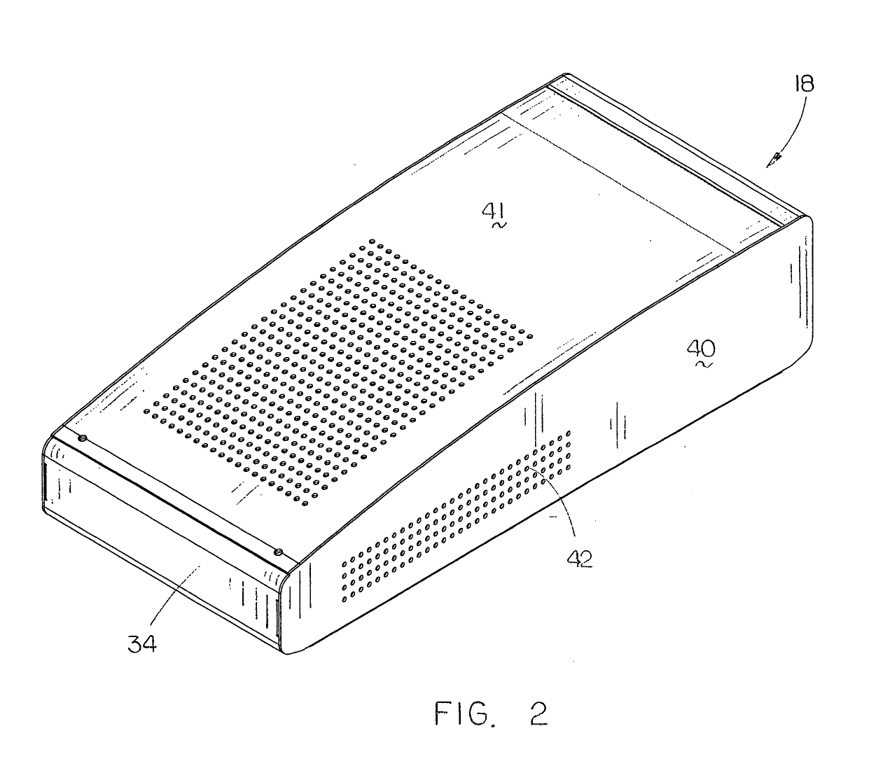

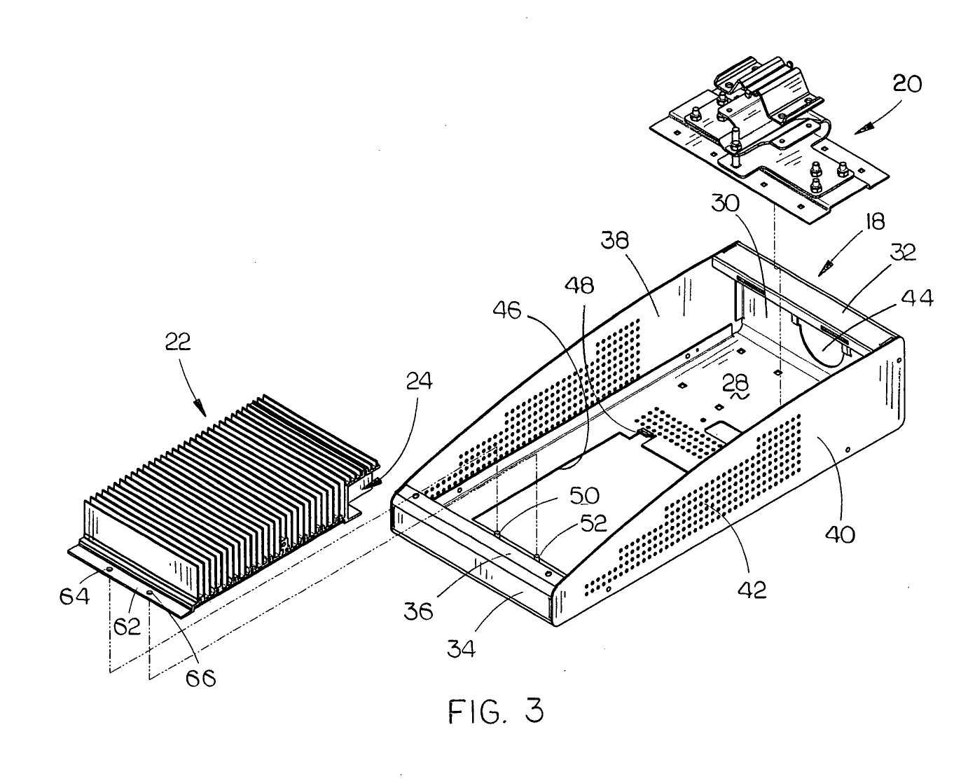

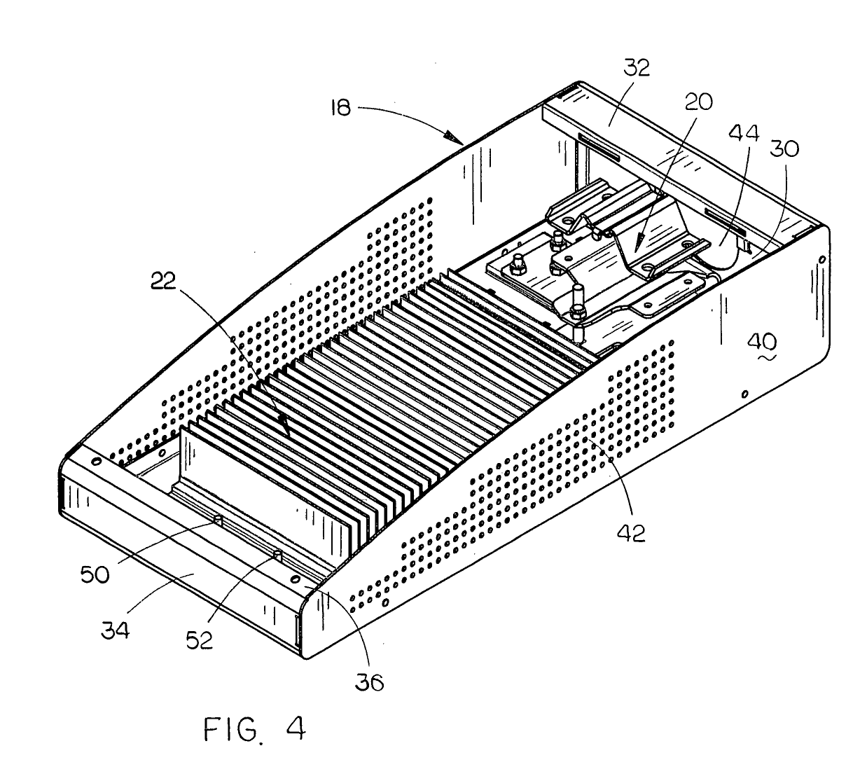

As seen in FIG. 3, bottom wall 28, side wall 38 and side wall 40 are provided with a plurality of perforations formed therein which are referred to generally by the reference numeral 42. As seen in FIG. 2, cover 41 is also provided with a plurality of perforations formed therein.

Inner wall 30 has an opening 44 formed therein which is adapted to have the support arm 12 extending therethrough. Bottom wall 28 has a cut-out 46 formed therein as seen in FIG. 3. Bottom wall 28 is also provided with a lip 48 which dwells in a plane above bottom wall 28 for a purpose to be described hereinafter. A pair of threaded studs 50 and 52 is secured to bottom wall 28 outwardly of the outer end of cut-out 46 and which extends upwardly therefrom.

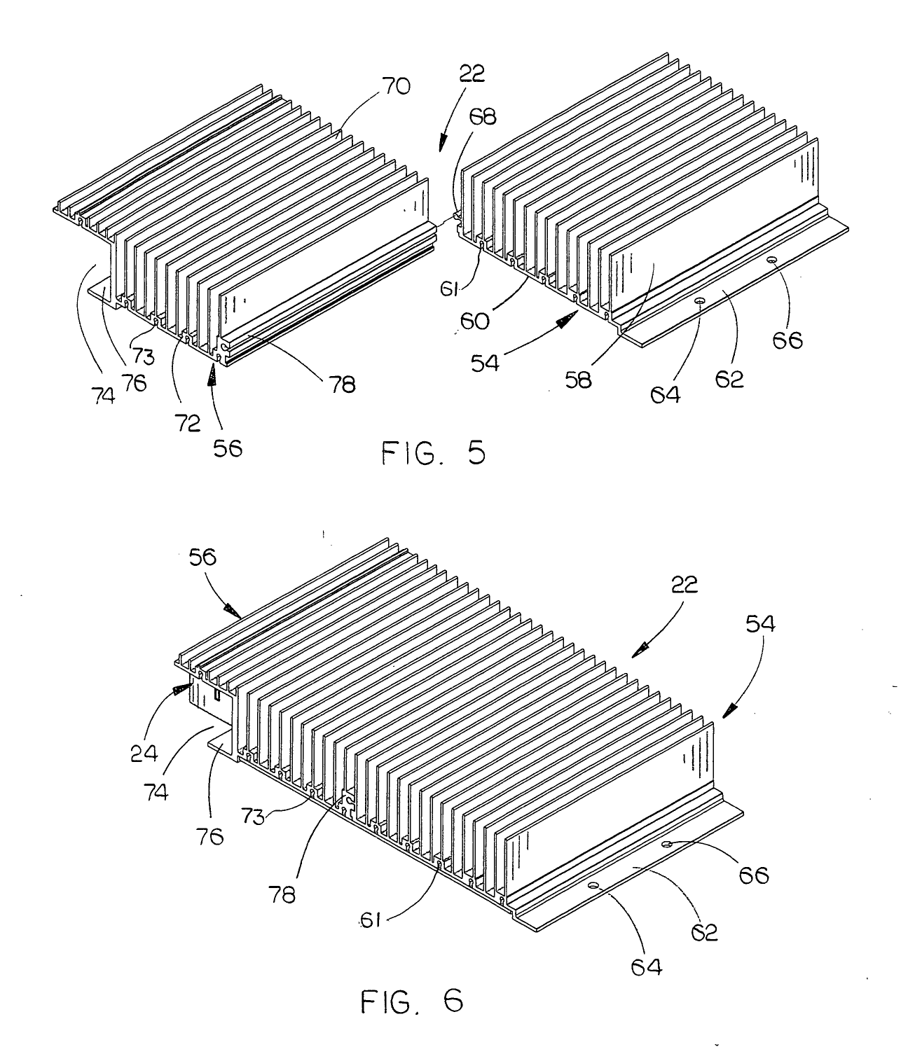

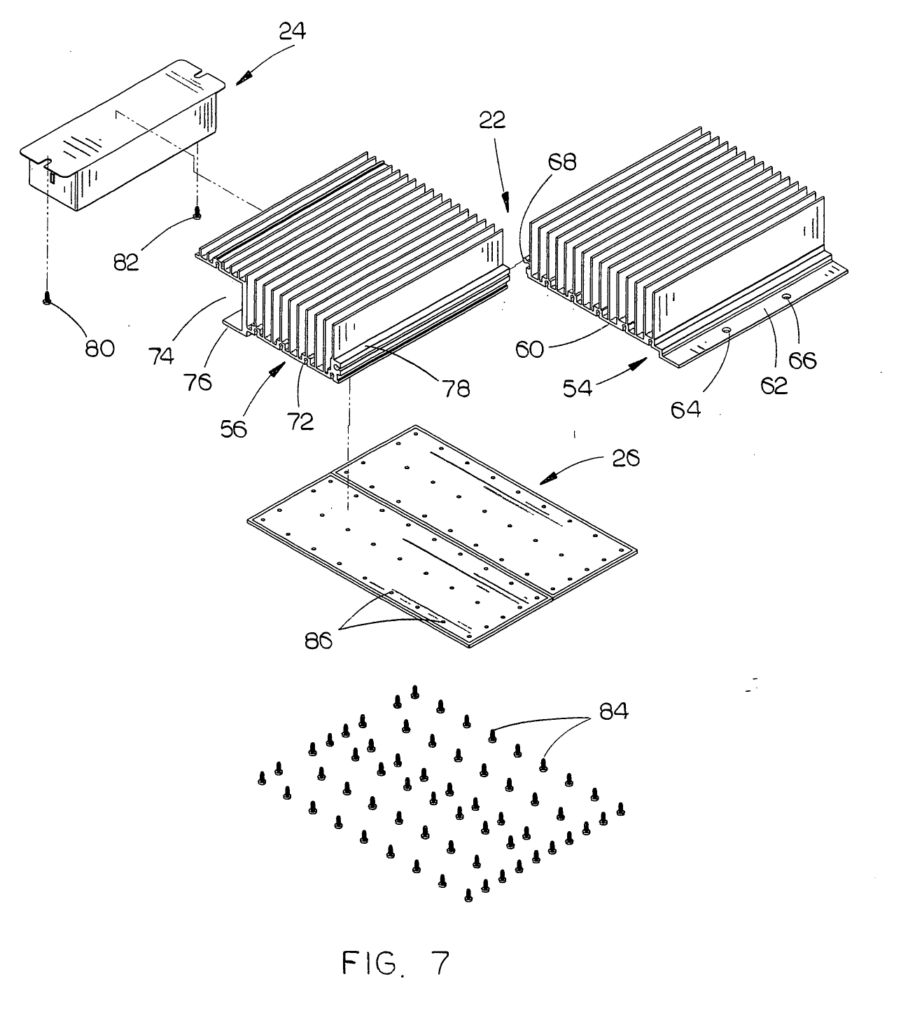

Preferably, heat sink assembly 22 is comprised of an outer heat sink member 54 and an inner heat sink member 56 which are selectively joined together to form heat sink assembly 22. Heat sink assembly 22 could be of one-piece construction. Outer heat sink member 54 has a plurality of spaced-apart fins 58 extending upwardly from bottom or base 60 thereof. Base 60 has a plurality of slots 61, as seen in FIGS. 5 and 6, extending upwardly thereinto. Flange 62 extends outwardly from outer heat sink member at the lower outer end thereof and has a pair of openings 64 and 66 formed therein. Outer heat sink member 54 has a horizontally disposed connector member 68 which extends therefrom at the inner end thereof.

Inner heat sink member 56 has a plurality of spaced-apart fins 70 extending upwardly from bottom or base 72 thereof. Base 72 has a plurality of slots 73 extending upwardly thereinto as seen in FIGS. 5 and 6. Inner heat sink member 56 has a recessed portion 74 formed therein as seen in FIG. 5 and has a flange 76 extending therefrom. Inner heat sink member 56 has a horizontally disposed connector member 78 at its outer end as seen in FIG. 5 which is adapted to receive the connector member 68 of outer heat sink member 54 so that the heat sink members 54 and 56 may be selectively secured together to form the heat sink assembly 22 as seen in FIG. 6. Power supply 24 is secured to heat sink member 56 within recessed area 74 by screws 80 and 82. Heat sink assembly 22 is preferably constructed of an extruded aluminum material.

LED panel 26 is of conventional design and is secured to bottom 60 of heat sink member 54 and bottom 72 of heat sink member 56 by a plurality of self-tapping screws 84 which extend upwardly through openings 86 in LED panel 26 and into slots 61 and 73 formed in bottoms 60 and 72 of heat sink members 54 and 56 respectively. Power supply 24 is electrically connected to LED panel 26 in conventional fashion.

The heat sink assembly 22 with the LED panel 26 secured thereto is positioned within case 18 and secured thereto as will now be described. Flange 76 of heat sink assembly 22 is inserted below lip 48 and the flange 62 is positioned so that openings 64 and 66 receive the threaded studs 50 and 52 therein respectively. Nuts are then threadably secured onto studs 50 and 52 to securely maintain heat sink assembly 22 in the interior of case 18.

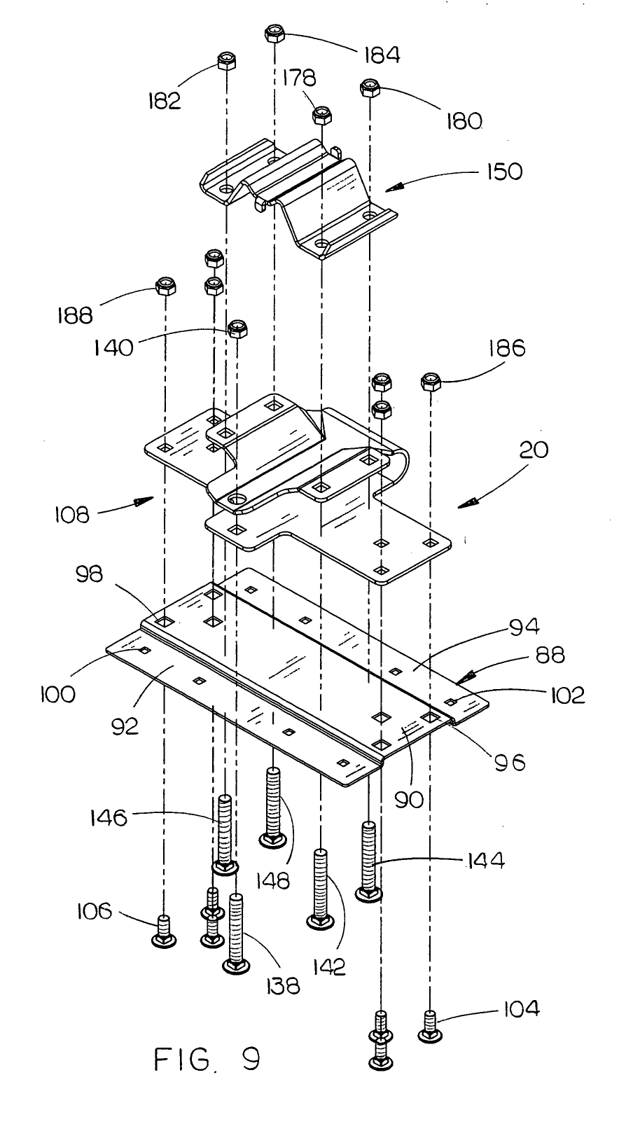

Clamp assembly 20 includes a clamp bracket 88 having an elevated central portion 19 and flanges 92 and 94 extending therefrom as seen in FIG. 9. Central portion 90 has a plurality of bolt openings 96 formed therein at one end thereof and a plurality of bolt openings 98 formed therein at the other end thereof. Flange 92 has a plurality of bolt openings 100 formed therein and flange 94 has a plurality of bolt openings 102 formed therein. Bolt openings 96 receive bolts 104 extending upwardly therethrough and bolt openings 98 receive bolts 106 extending upwardly therethrough.

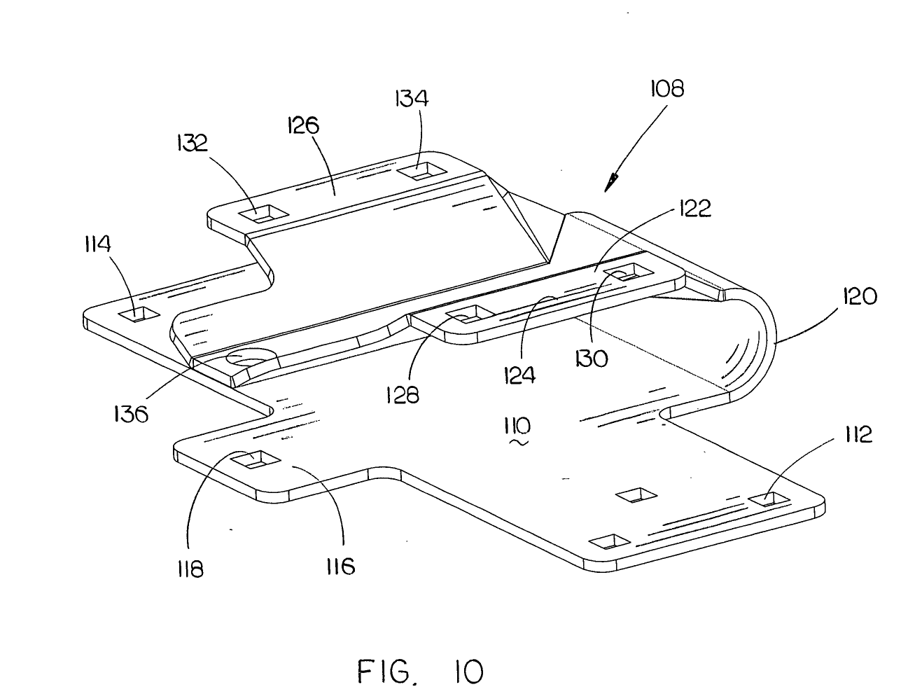

Clamp assembly 20 also includes a lower clamp 108 as seen in FIG. 10. Lower clamp 108 includes a base portion 110 having a plurality of bolt openings 112 formed therein at one end thereof and a plurality of bolt openings 114 formed therein at its other end. Bolt openings 112 register with bolt openings 96 in clamp bracket 88 and bolt openings 114 register with bolt openings 98 in clamp bracket 88. Base portion 110 has an ear or tab 116 extending therefrom at the outer side thereof which has a bolt opening 118 formed therein. Lower clamp 108 includes an arcuate or curved portion 120 which extends upwardly from the inner end of base portion 110 as seen in FIG. 10. A tube or arm support 22 extends from the upper end of curved portion 120 and has laterally extending wings 124 and 126. Wing 124 has bolt openings 128 and 130 formed therein with wing 126 having bolt openings 132 and 134 formed therein. A bolt opening 136 is formed in the free end of tube support 122 which registers with bolt opening 118. Adjustment bolt 138 extends upwardly through bolt opening 118 in ear 116 and extends upwardly through opening 136 in tube support 122. An adjustment nut 140 is threadably mounted on adjustment bolt 138 above tube support 122. Bolts 142 and 144 extend upwardly through bolt openings 128 and 130 in wing 124 respectively. Bolts 146 and 148 extend upwardly through bolt openings 132 and 134 in wing 126 respectively. Tube support 122 is shaped so as to cradle the lower portion of the support arm 12 to which the clamp assembly 20 will be attached.

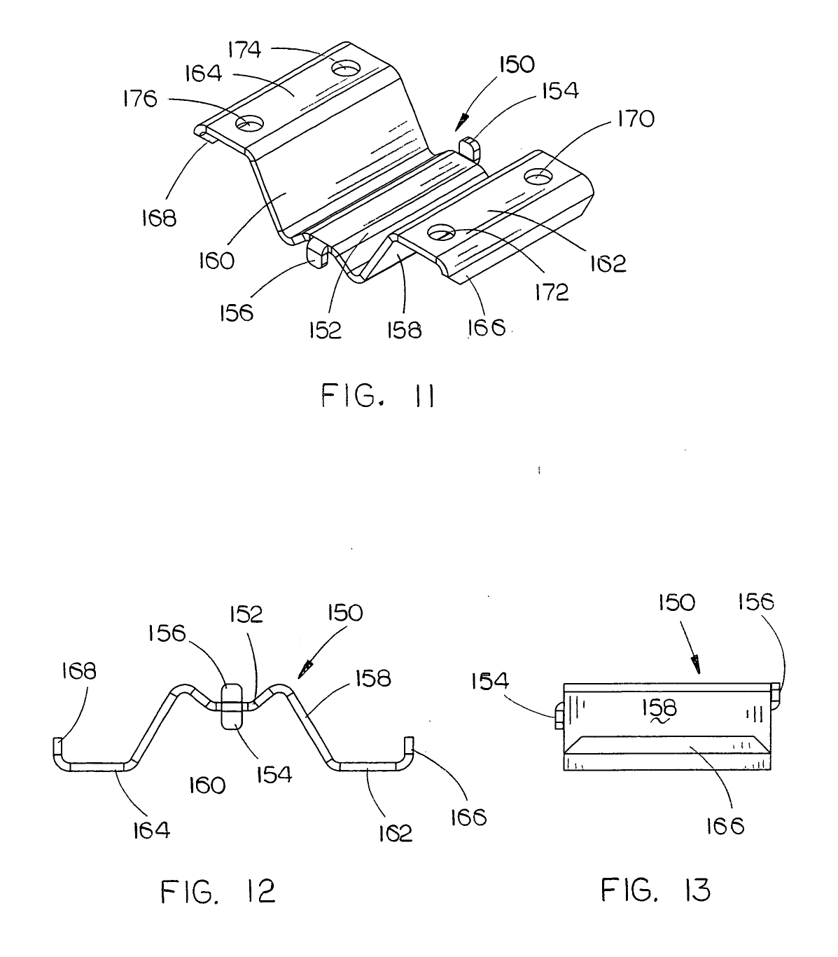

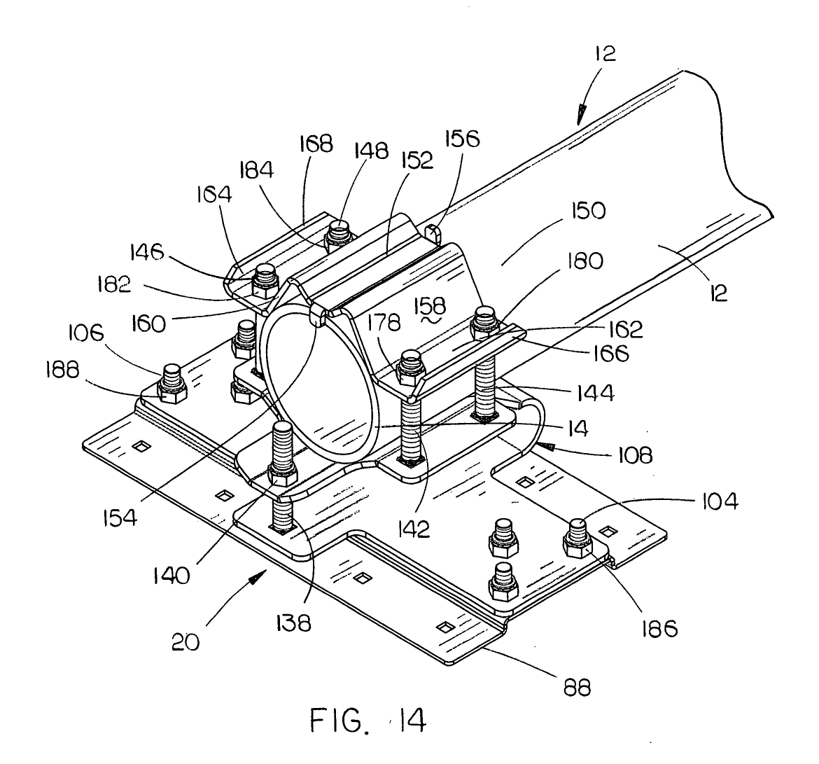

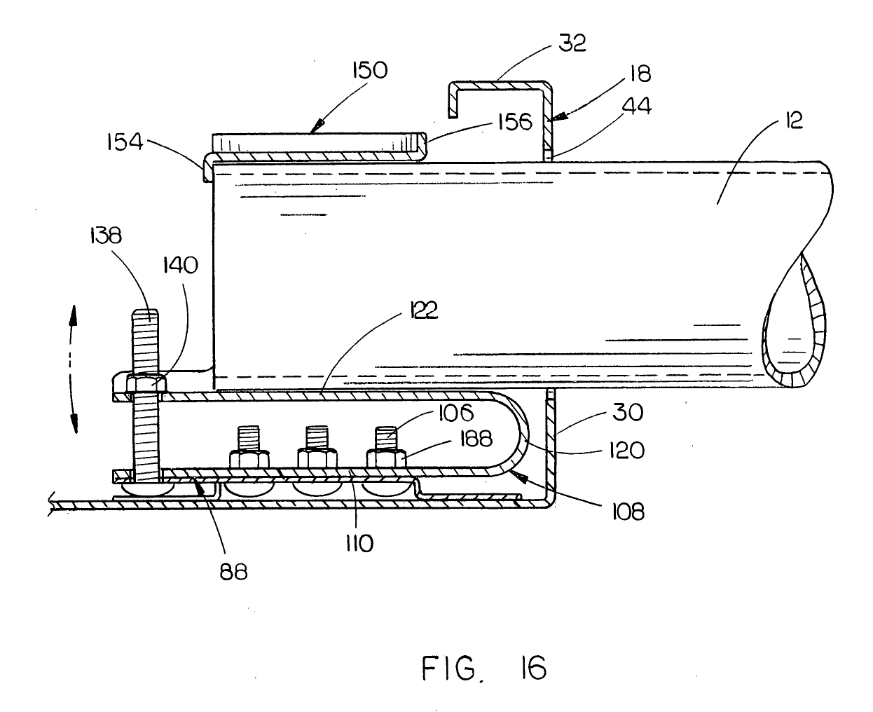

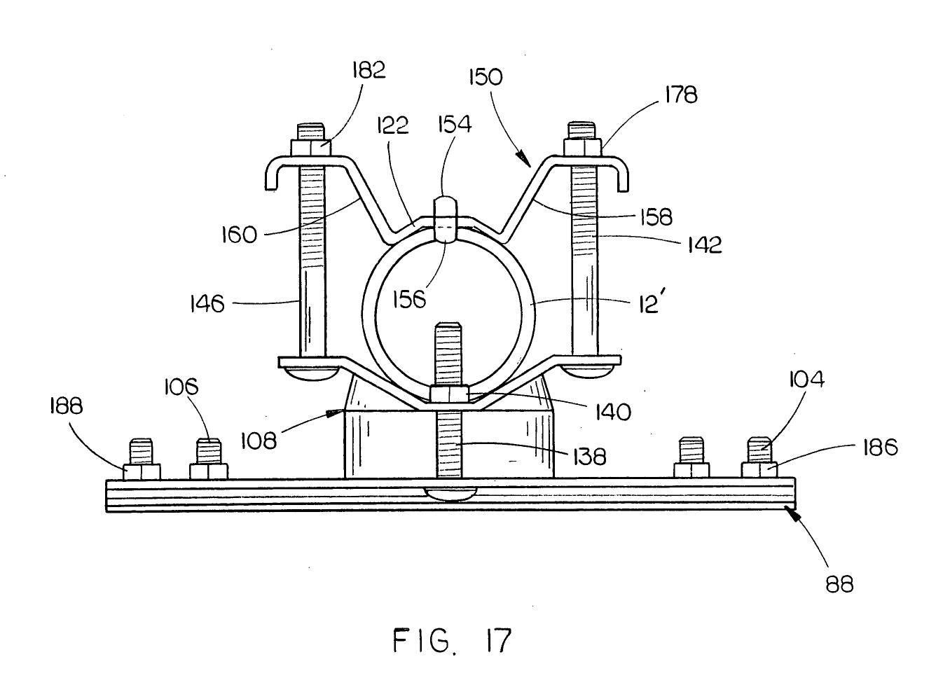

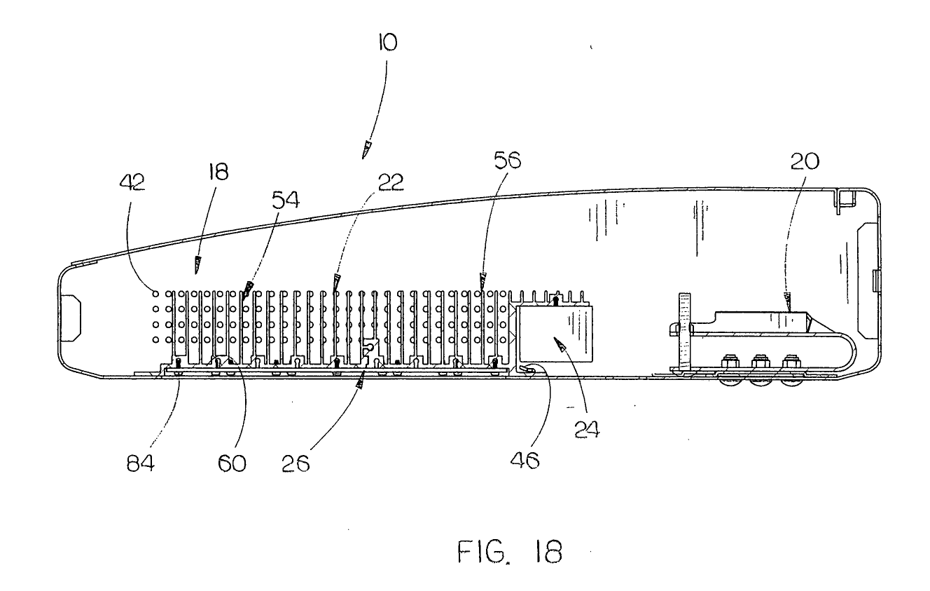

Clamp assembly 20 also includes a selectively reversible upper clamp 150 which is shown in a first position in FIGS. 3, 8, 9 and 12-16 and shown in the second position in FIGS. 11 and 17. Upper clamp 150 will be described as being in its first position for clarity purposes. Upper clamp 150 includes a generally V-shaped or U-shaped central portion 152 having a downwardly extending lip or stop 154 at its outer end and an upwardly extending lip or stop 156 at its inner end. Sides 158 and 160 extend downwardly from central portion 152 in a diverging manner and which terminate in flanges 162 and 164 respectively which terminate with upwardly extending end portions 166 and 168 respectively. Bolt openings 170 and 172 are formed at flange 162 and bolt openings 174 and 176 are formed in flange 164.

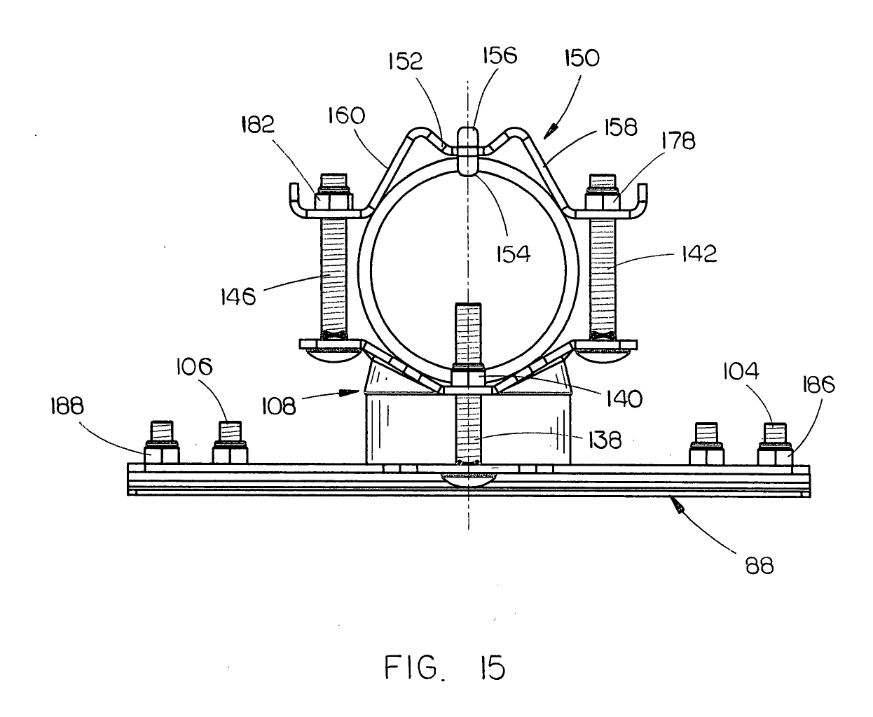

When upper clamp 150 is in its first position, as illustrated in FIG. 14, bolts 142 and 144 extend through bolt openings 170 and 172 in upper clamp 150 and bolts 146 and 148 extend upwardly through openings 174 and 176 in upper clamp 150 respectively. When upper clamp 150 is in its second position, as illustrated in FIG. 17, bolts 142 and 144 extend upwardly through openings 172 and 170 respectively with bolts 146 and 148 extending upwardly through bolt openings 176 and 174 respectively. Regardless of the position of upper clamp 150, nuts 178 and 180 are threadably secured to the upper ends of bolts 142 and 144 respectively and nuts 182 and 184 are threadably mounted on the upper ends of bolts 146 and 148 respectively.

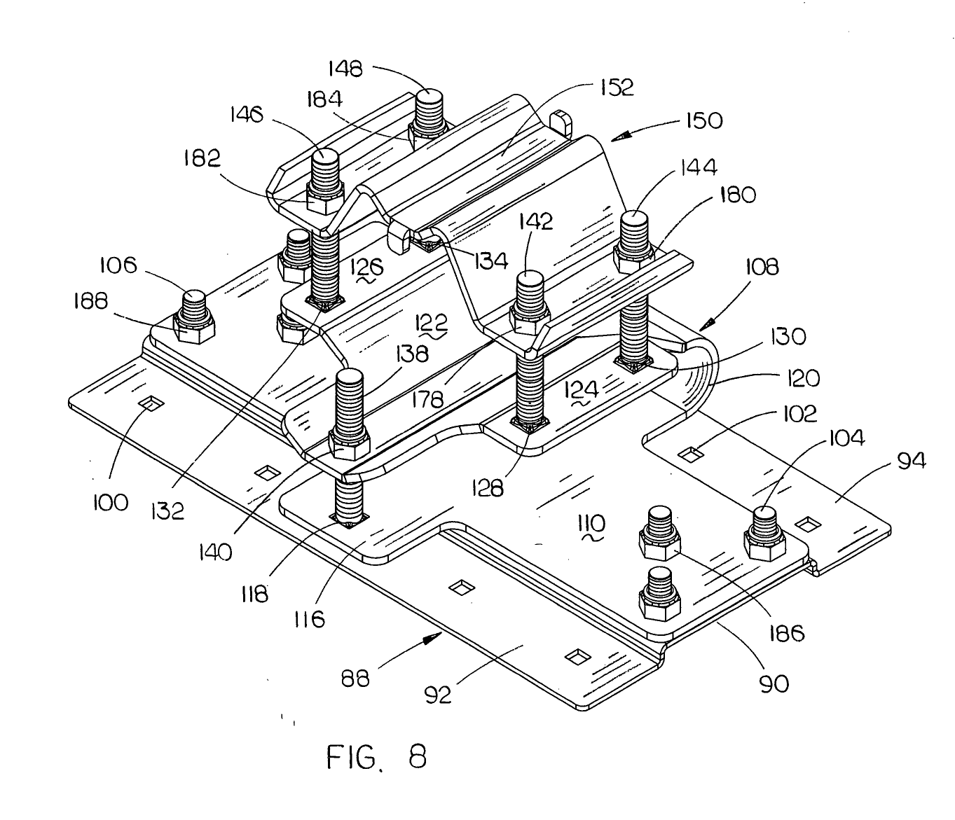

The clamp assembly 20 is secured to bottom wall 28 thereof by bolts extending downwardly through the openings 100 and 102 in clamp bracket 88. The LED light module 10 is then maneuvered so that the outer end of the support arm 12 extends through the opening 144 so that the underside of the support arm 12 is received by the tube support 122. When the upper clamp 150 is in the position of FIGS. 8 and 14, the LED light module 10 is moved inwardly with respect to support arm 12 until the outer end of the support arm 12 engages the lip 154. At that time, the nuts on bolts 142, 144, 146 and 148 will be tightened to clamp the support arm 112 to the clamp assembly 20.

The fact that the upper clamp 150 is selectively reversible enables the clamp to accommodate different diameters of support arm 12 as seen in FIG. 17. When the upper clamp 150 is in the position shown in FIG. 17, the outer end of the support arm 12 engages the lip 156 which is now at the outer end of the upper clamp 150. The power wires extending outwardly from the interior of support arm 12 will then be connected to the power supply 24.

If the light module 10 is not in the desired horizontal position, the nut 140 may be threadably moved upwardly or threadably moved downwardly on adjustment bolt 138 to alter the position of the lower clamp 108. The curved portion 120, since it is comprised of a spring steel material, permits the tube support 122 to be moved upwardly or downwardly with respect to base 110 as adjustment nut 140 is threadably rotated with respect to bolt 138. The spring effect of curved portion 120 also serves to limit vibrations in the assembly caused by wind or the like.

A cover 41 is then installed on the case 18. When the LED panel 26 is illuminated, light from the LEDs thereof will pass downwardly through the cut-out 46 in bottom wall 28. The perforations in the case and the cover serve to permit air to pass therethrough to aid in cooling the assembly. The heat sink assembly 22 aids in the dissipation of heat created by the LED panel 26.

The heat sink assembly 22, power supply 24 and LED panel 26 form a module which may be easily assembled during manufacture and easily replaced as a module should the module require repair or replacement. The heat sink assembly 22, power supply 24 and LED panel 26 may be easily removed from the module by simply disconnecting the power supply 24 from the wires extending outwardly through the support arm 12, removing the nuts on the studs 62 and 64 and then moving the outer end of the module upwardly so that flange 76 disengages from lip 48. Once the repairs have been incorporated into the module comprising the heat sink 22, power supply 24 and LED panel 26, the unit may then be repositioned in the case 18.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. An LED light module for attachment to the outer end of a support arm which extends from a support pole; comprising:
a case having a selectively closable top wall and a bottom wall with a cut-out formed therein with the case being secured to the outer end of the support arm;
a substantially flat LED panel having upper and lower sides;
a heat sink secured to and mounted on said upper side of said LED panel;
and a power supply secured to said heat sink whereby said LED panel, said heat sink and said power supply form a module which may be inserted into the case through the selectively closable top wall thereof and selectively removably secured to the case as a module so that said LED panel directs light downwardly through the cut-out in the bottom wall of the case.

2. The LED light module of claim 1 wherein said heat sink comprises a pair of heat sink members selectively secured together.

3. The LED light module of claim 1 wherein said heat sink has a recessed area formed therein which receives said power supply.

4. The LED light module of claim 1 wherein said LED panel is secured to said heat sink by a plurality of screws extending upwardly through said LED panel into said heat sink.

5. The LED light module of claim 4 wherein said heat sink is secured to the case by screws.

6. The LED light module of claim 1 wherein said heat sink has inner and outer ends, first and second sides, a top and a bottom, and wherein a first flange extends from said inner end of said heat sink at the bottom thereof and wherein a second flange extends from said outer end of said heat sink at the bottom thereof, and wherein said first and second flanges are secured to the bottom wall of the case.

7. The LED light module of claim 6 wherein said second flange is secured to the bottom wall of the case by screws.

8. The LED light module of claim 7 wherein the cut-out formed in the bottom wall has inner and outer ends and wherein the bottom wall of the case has a lip formed therein adjacent the inner end of the cut-out and wherein said first flange is selectively received by said lip.

9. The LED light module of claim 1 wherein said heat sink has inner and outer ends, first and second sides, a top and a bottom, and wherein said inner end of said heat sink has a recess formed therein below said top thereof, and wherein said power supply is received in said recess.

10. The LED light module of claim 9 wherein said power supply is secured to said heat sink by screws.

11. In combination:
an upstanding support pole;
a tubular support arm, having inner and outer ends, secured at its said inner end to said support pole and extending laterally therefrom;
an LED light case having inner and outer ends, a bottom wall, an open upper end, a cover selectively removably closing said open upper end of said case;
said inner end of said case having an opening formed therein which receives said outer end of said support arm;
a bottom clamp including a substantially horizontally disposed base portion having inner and outer ends and first and second sides, an elongated tube support positioned above said base portion having inner and outer ends, said inner ends of said base portion and said tube support being joined by an arcuate portion;
said base portion being secured to said bottom wall of said light case;
said tube support being parallel to said support arm so that said outer end of said tubular support arm may be positioned thereon;
an upstanding adjustment bolt, having upper and lower ends;
said adjustment bolt extending between said outer ends of said base portion and said tube support whereby the outer end of said tube support may be vertically adjusted with respect to said outer end of said base portion;
a top clamp extending over said outer end of said support arm above said lower clamp;
said top clamp being secured to said bottom clamp to clamp said outer end of said support arm therebetween.

12. The combination of claim 11 wherein said bottom clamp is comprised of spring steel.

13. The combination of claim 11 wherein said top clamp is selectively reversible to accommodate support arms having different diameters.

14. The combination of claim 11 wherein said tube support is generally U-shaped in cross-section.

15. The combination of claim 11 wherein said upper clamp includes a downwardly extending stop at its outer end which is positioned outwardly of and adjacent to the outer end of said outer end of said support arm and includes an upwardly extending stop at its inner end.

16. The combination of claim 15 wherein said top clamp is selectively reversible to accommodate support arms having different diameters.
